(19) United States
(12) Patent Application Publication
(10) Pub. No.: US 2008/0185968 A1
(43) Pub. Date: Aug. 7, 2008

(54) Method For Lamp Life Control of a Gas Discharge Lamp, a Gas Discharge Lamp Driver Circuit, a Gas Discharge Lamp and an Assembly of a Gas Discharge Lamp and a Lamp Driver Circuit

(75) Inventors: Josephus Johannes De Groot, Eindhoven (NL); Lars Rene Christian Waumans, Eindhoven (NL); Geert Willem Van Der Veen, Eindhoven (NL); Theodoor Hubert Stommen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,017

(22) PCT Filed: Mar. 27, 2006
(86) PCT No.: PCT/IB2006/050918

§ 371 Date: Sep. 28, 2007

(30) Foreign Application Priority Data
Apr. 4, 2005 (EP) 05102618.5

(51) Int. Cl. H05B 41/36

(52) U.S. Cl. 315/157

(57) ABSTRACT

The lamp life of a gas discharge lamp (6) depends inter alia on the deterioration of an electrode of the lamp during operation. The deterioration depends on an operating temperature of the electrode. A method according to the present invention for controlling the lamp life includes controlling the electrode temperature during operation by generating a temperature signal (12) representing the electrode temperature and providing said signal to a lamp driver circuit (4) operating said lamp. The lamp driver circuit controls an operating signal (10) supplied to the lamp (6) in order to control the electrode temperature to lie within a predetermined temperature range, thereby minimizing damage to the electrode during operation.

The present invention relates to a method for operating a gas discharge lamp, a gas discharge lamp, and a lamp driver circuit. In particular, the present invention relates to a method for controlling a lamp life of a gas discharge lamp, and to a gas discharge lamp, a lamp driver circuit, and an assembly thereof configured for performing said method.

It is known that the lamp life of a low-pressure gas discharge fluorescent lamp, such as a TL-lamp or a CFL-lamp, depends inter alia on the deterioration of the electrodes of the lamp, since the condition of the electrodes deteriorates during operation. However, the amount of damage to the electrodes depends mainly on an operating temperature of the electrodes. Two types of damage govern the deterioration of the electrodes: sputter damage and evaporation damage.

A sputter damage rate typically is large when the electrode is relatively cold, but the damage rate decreases with increasing temperature. When the temperature is high enough for thermionic emission, the sputter damage rate becomes small.

An evaporation damage rate increases with increasing temperature. At a certain temperature, the sputter damage rate becomes negligible with respect to the evaporation damage rate.

The electrode temperature is at an optimum with respect to the lifetime of the lamp when the sum of the sputter damage rate and the evaporation damage rate, i.e. a total damage rate, is at a minimum. In practice, with electrodes made of a coiled tungsten wire covered with a mixture of Ca, Ba and Sr oxides, the total damage rate is relatively small when the temperature lies in an operating temperature range, i.e. between certain boundaries T₁ and T₂. For ignition the operating temperature may be in the range of about 900 K-1000 K, and the total damage is at a minimum at a temperature of about 950 K.

For the above-mentioned kind of electrodes it is known that thermionic emission occurs at temperatures which correspond to a resistance ratio of tungsten

$$\frac{{R}_{hot}}{{R}_{cold}} \geq 4$$

in which R_{cold} ld represents the electrical resistance at room temperature and Rₕₒₜ the electrical resistance at the operating temperature.

Conventionally, using the above technical considerations, lamp driver circuits and gas discharge lamps are standardized and designed such that the electrodes may be preheated before ignition such that the resistance ratio is about 4.75.

Similar considerations lead to similar rules for steady-state operation. The temperature range, however, may be different. An appropriate spot temperature for the above-indicated coated tungsten wire may be in the range 1400-1600 K, while the rest of the electrode may be at lower temperature. According to empirical findings lamp life is high for lamps without additional heating current when the lamp current Iₗₐₘₚ is in the range 1-1.5 times the current I_{R4}, I_{R4} being the current at which the above-mentioned resistance ratio is 4 (measured for the electrode without discharge).

Although the average lifetime of the lamps may be acceptable with such a standardized lamp and driver circuit, the lifetime of individual lamps may be shorter than expected e.g. due to manufacturing tolerances and manufacturer differences.

It is desirable to have a method for optimizing a lifetime of a gas discharge lamp. Further, it is desirable to have a gas discharge lamp and lamp driver circuit for performing said method.

In an aspect of the present invention there is provided a method for controlling a life time of a gas discharge lamp, the method comprising: providing a temperature signal representing a temperature of an electrode of said gas discharge lamp to a lamp driver circuit operating said lamp; and controlling at least one operating signal supplied by said lamp driver circuit to said lamp in response to said temperature signal for controlling the electrode temperature to lie within a predetermined temperature range.

In particular in applications where replacement of defect lamps may be difficult and/or expensive, it is advantageous to control the temperature of the electrodes, since controlled electrode temperature may result in an increased lamp life.

In an embodiment of the method, the temperature signal corresponds to a cathode fall voltage. In an embodiment the cathode fall voltage may be determined by a conducting band positioned around the lamp, said cathode fall voltage being determined by measuring a potential of said conducting band. In a further embodiment, the potential of a lamp cap near the electrode is determined in order to determine the cathode fall voltage. In another embodiment, the cathode fall voltage is determined by measuring a potential of an electrode shield. Such an electrode shield is provided in some known lamps.

In another embodiment the temperature signal corresponds to a electrode coil voltage. The electrode coil referred to is a coiled tungsten electrode, for example. The voltage drop over the electrode coil is, for a given discharge current and a given heating current, a measure for the effective coil resistance, and thereby for the effective coil temperature. Thus, in this embodiment, the voltage over the electrode coil is used as the temperature signal.

In a further embodiment, the cathode fall voltage and the electrode coil voltage are used in combination as a temperature signal. The cathode fall voltage may be more accurate for determining a temperature of a cold electrode, whereas the electrode coil voltage may be more suited to determine a temperature of a hot electrode. Using both signals enables an accurate measurement for both a cold and a hot electrode.

In response to a cold or a hot electrode, the control circuit of the lamp driver circuit controls at least one operating signal. In an embodiment, the at least one operating signal is a heating current supplied to the lamp. The heating current is an operating signal known in the art for heating the electrode and keeping the electrode at a suitable temperature. If the temperature indicated by the temperature signal is not at a desired level, the control circuit may adjust the heating current to adjust the temperature. In particular, if the temperature is below a desired temperature, the heating current is increased; if the temperature is above a desired temperature, the heating current is decreased, if possible.

In another embodiment an electrical connection between an electrode shield and a current carrying lead wire is controlled in response to the temperature signal. For a given discharge current the electrode temperature is lower when the electrode shield is connected to a lead wire, in particular the current carrying lead wire, compared to a situation without a connection. The lead wires provide a current (discharge and heating current) to the electrode. The current carrying lead wire is the one of the two lead wires that carries the highest current (discharge current and heating current; the other lead wire carries the lowest current, possibly only the heating current, if present). As mentioned above, establishing a connection between the current carrying lead wire and the electrode shield is in particular suitable for lowering the electrode temperature.

In a further embodiment the lamp driver circuit controls a variable impedance element connected between the electrode shield and the current carrying lead wire. By controlling a variation of the impedance, the temperature may be controlled. In particular, if the temperature is above a predefined temperature, the impedance is decreased, if possible. In a further aspect of the present invention, there is provided an assembly of a low-pressure gas-discharge fluorescent lamp and a lamp driver circuit for performing the method according to the present invention. The lamp driver circuit and the gas discharge lamp are electrically connected for supplying at least one operating signal from the lamp driver circuit to the lamp and for supplying at least one temperature signal representing an electrode temperature from the lamp to the lamp driver circuit. The lamp driver circuit comprises a control circuit for controlling the at least one operating signal in response to said temperature signal for controlling the electrode temperature to lie within a predetermined temperature range.

In another aspect, the present invention provides a gas discharge lamp for use in said assembly. In an embodiment, such a lamp may comprise a conducting band positioned around the lamp for determining a cathode fall voltage by measuring a voltage of said conducting band.

In another embodiment of the lamp an electrode shield is provided around the electrode of the lamp and a feed through conductive wire provides an electrical connection between a terminal on the outside of the lamp and the electrode shield for electrically connecting the lamp driver circuit and the electrode shield.

In yet another embodiment of the lamp a switching element is connected between an electrode shield and a lead wire and is electrically connectable to the lamp driver circuit for making an electrical connection between the electrode shield and the lead wire in response to an operating signal provided by the lamp driver circuit.

In a further embodiment of the lamp according to the present invention, a controllable variable impedance element is connected between an electrode shield and a lead wire and is electrically connectable to the lamp driver circuit for making an electrical connection between the electrode shield and the lead wire by controlling the impedance of the variable impedance element by the lamp driver circuit.

In another embodiment of the lamp, the gas discharge lamp is provided with said feed through wire for connecting the electrode shield and the lamp driver circuit and is provided with the variable impedance element connected between the electrode shield and the current carrying lead wire. The impedance may be controlled by the lamp driver circuit. As mentioned above, a combination of the above-described measures provides more accurate control and thus a longer lamp life.

In another aspect, the present invention provides a lamp driver circuit for use in said assembly. The lamp driver circuit comprises a control circuit for generating an operating signal in response to a temperature signal.

In an embodiment of the lamp driver circuit, the operating signal is a heating current. In another embodiment of the lamp driver circuit, the operating signal is a switch signal for controlling a switch of the lamp connected between an electrode shield and a lead wire. In yet another embodiment, the operating signal is an impedance signal for controlling a variable impedance element of the lamp connected between an electrode shield and a lead wire.

These and other aspects of the present invention will be apparent from and elucidated with reference to the embodiments described hereinafter.

The annexed drawing shows a non-limiting exemplary embodiment, wherein:

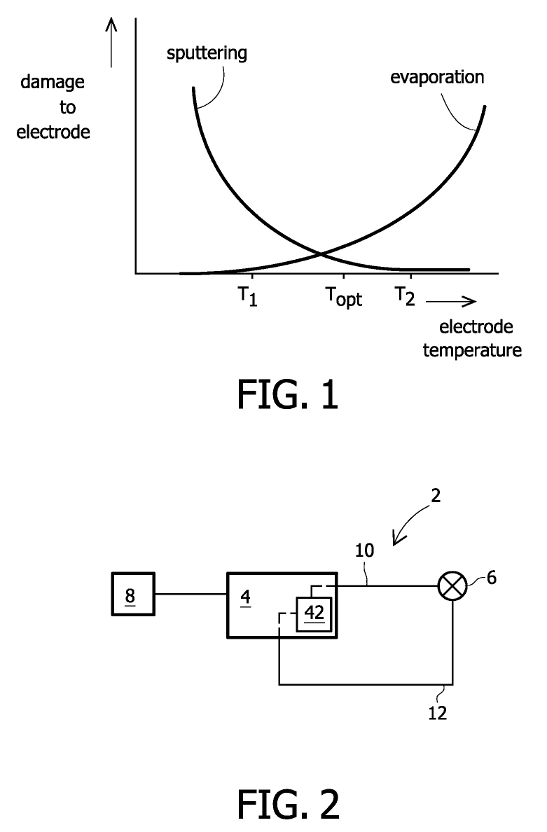

FIG. 1 shows a graph illustrating occurring damage to an electrode as a function of the electrode temperature;

FIG. 2 schematically shows a circuit scheme of an assembly of a lamp driver circuit and a lamp according to the present invention;

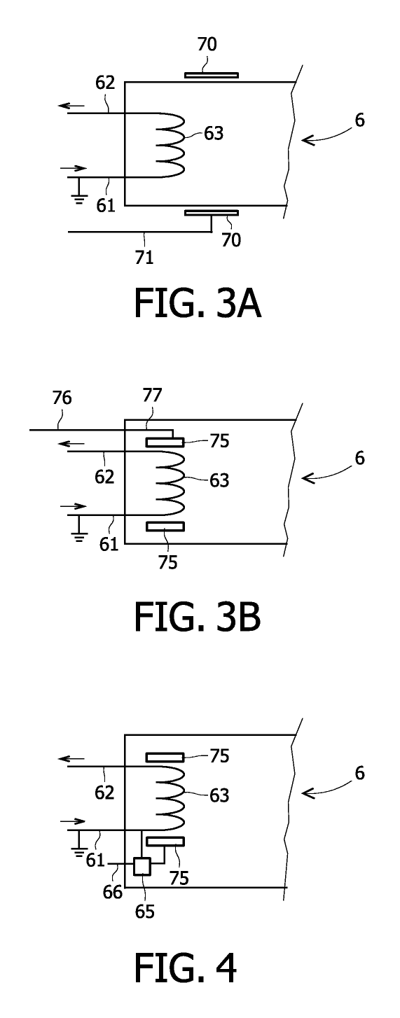

FIGS. 3A and 3B schematically show embodiments of a lamp for determining a cathode fall voltage;

FIG. 4 schematically shows an embodiment of a lamp enabled for making an electrical connection between an electrode shield and a lead wire.

In the drawings, identical reference numerals indicate similar components or components with a similar function.

FIG. 1 illustrates an electrode operating temperature with respect to damage to the electrode and thus the lifetime of a low-pressure gas discharge lamp. The damage to the electrode (vertical axis) is plotted against the electrode temperature (horizontal axis). Two kinds of damage are shown. At a low temperature, the electrode is mostly damaged by sputtering. At a high temperature evaporation of an electrode coil coating results in damage to the electrode. In a temperature range T₁-T₂ the total damage rate is relatively small and at an optimum temperature Tₒₚₜ the damage rate is at a minimum. As mentioned above, it is known that in a practical embodiment the temperature range T₁-T₂ is about 900 K-about 1000 K and the optimum temperature Tₒₚₜ is about 950 K for ignition and the temperature range T₁-T₂ for the hot spot of the electrode is about 1400 K-about 1600 K for steady-state operation.

FIG. 2 shows a circuit 2 according to the present invention comprising a lamp driver circuit 4 and a low-pressure gas discharge lamp 6. The lamp driver circuit 4 is connected to a supply voltage source 8, e.g. a mains voltage source or any other suitable voltage source. The lamp driver circuit 4 is connected to the lamp 6 for supplying at least one operating signal 10, e.g. a supply voltage or supply current, to the lamp 6 and for receiving at least one temperature signal 12 from the lamp 6. The lamp driver circuit 4 comprises a control circuit 42 which is configured to receive the at least one temperature signal 12 and to control at least one operating signal 10 in response to the temperature signal 12. The lamp driver circuit 4 may be configured to perform a number of operations with respect to the lamp operation, for example preheating the electrodes of the lamp 6 before igniting the lamp 6. In operation, the lamp driver circuit 4 supplies a supply voltage or current as an operating signal 10 to the gas discharge lamp 6. To enable control of the lamp life, the temperature of one or more electrodes of the lamp 6 is sensed and a temperature signal 12 representing the temperature of the one or more electrodes is generated and provided to the lamp driver circuit 4.

The temperature signal 12 is supplied to the control circuit 42 comprised in the lamp driver circuit 4. In response to the temperature signal 12, the control circuit 42 may adjust at least one of the operating signals 10.

The electrode temperature may be determined using different practical embodiments. A number of such exemplary embodiments are illustrated in FIGS. 3A, 3B and 4.

FIG. 3A show an end of a gas discharge lamp 6 having two contact terminals 61 and 62 for receiving a supply voltage or current as a first operating signal. The terminal 61 is connected to ground. The first operating signal is supplied to an electrode 63. The first operating signal may be a discharge current and possibly a heating current flowing in the direction of the indicated arrows. Further, a conducting band 70, e.g. made of copper, is positioned at the outside of the lamp 6 near the electrode 63, but it may as well be positioned further away from the electrode 63, e.g. closer to the lamp end. In an embodiment, the conducting band 70 may be part of or may be a lamp cap. A terminal 71 is electrically connected to the conducting band 70 to enable an electrical connection to a lamp driver circuit.

In operation, a potential is generated on the conducting band 70. The lamp driver circuit may detect said potential as a voltage compared to ground or, more accurately, compared to the floating, i.e. not-grounded contact terminal 62. The detected voltage is a measure for the cathode fall voltage. The cathode fall voltage is a measure for the temperature of the electrode 63. Thus, in this embodiment, the conducting band 70 may generate a suitable temperature signal to be supplied to the lamp driver circuit.

FIG. 3B shows, like FIG. 3A, an end of a gas discharge lamp 6 having two contact terminals 61 and 62 for receiving a supply voltage or current as a first operating signal. Terminal 61 is connected to ground. Via the lead wires connected to the terminals 61 and 62 the first operating signal is supplied to the electrode 63. In the embodiment of FIG. 3B an electrode shield 75 is present around the electrode 63. An additional terminal 76 is provided to enable an electrical connection to a lamp driver circuit. A feed through electrically conducting wire 77 connects the terminal 76 and the electrode shield 75.

The embodiment of FIG. 3B functions similar to the embodiment of FIG. 3A. In operation, a potential is generated on the electrode shield 75. The lamp driver circuit may detect said potential as a voltage compared to ground or, more accurately, compared to the floating contact terminal 62. The detected voltage is a measure for the cathode fall voltage. The cathode fall voltage is a measure for the temperature of the electrode 63. Thus, in this embodiment, the electrode shield 75 may generate a suitable temperature signal to the lamp driver circuit.

Referring to FIGS. 3A and 3B, in a further embodiment, the temperature of the electrode 63 may be determined from the voltage drop over the contact terminals 61 and 62. The conducting band 70 and/or the electrode shield 75 need not be present, but one or both may still be present. The voltage drop over the contact terminals 61 and 62 at a given discharge current and a given heating current is a measure for the resistance of the electrode coil 63. The resistance of the electrode coil 63 is dependent on the temperature of the electrode coil as mentioned above. For example, if the electrode coil 63 is made of tungsten, the electrical resistance of the electrode coil during ignition is preferably at least 4 times as high as at room temperature, as explained above (Rₕ/R_{c}≧4). Thus, the resistance is a measure for the temperature of the electrode coil 63. The lamp driver circuit may therefore be configured to determine the electrode coil resistance via the electrical wiring providing the first operating signal to the lamp 6 as described in relation to FIGS. 3A and 3B.

The cathode fall voltage is a more accurate measure of the temperature for determining whether the electrode is cold, i.e. has a temperature that in operation results in more or less severe sputter damage. The electrode coil resistance is a more accurate measure of the temperature for determining whether the electrode is hot, i.e. has a temperature that in operation results in more or less severe evaporation damage. Therefore, in a practical embodiment, the cathode fall voltage and the electrode resistance may be determined using one of the embodiments according to FIGS. 3A and 3B to determine a cold or a hot electrode, respectively.

A control circuit comprised in a lamp driver circuit receiving one or more of the above-indicated temperature signals (a cathode fall voltage signal and an electrode resistance signal) may need to heat or cool the electrode of the gas discharge lamp in order to bring the temperature of the electrode at a desired temperature. The desired temperature may be a temperature within a predefined temperature range T₁-T₂, or it may be a predefined optimum or near-optimum temperature Tₒₚₜ, for example.

To heat the electrode, it is known to provide a heating current to the electrode. Thus, the control circuit may control the heating current. Increase of the heating current results in an increase of the temperature and a decrease of the heating current results in a decrease of the temperature.

FIG. 4 shows an embodiment of a lamp 6 according to the present invention. The lamp 6 comprises an element 65 for making an electrical connection between an electrode shield 75 present near the electrode 63 of the lamp 6 and a current carrying lead wire 61. The element 65 has a control terminal 66, which may be connected to a control circuit such as comprised in the lamp driver circuit.

In practice, it has been shown that making a connection between the electrode shield 75 and the current carrying lead wire 61 results in a decrease in temperature of the electrode 63. Thereto, the element 65 may be a switch for providing a connection, or a disconnection, or the element 65 may be a variable impedance element. The variable impedance (resistance) of the connection between the electrode shield 75 and the current carrying lead wire 61 provides a control range for adjusting the temperature of the electrode 63.

Above, in relation to FIGS. 3A, 3B and 4, two methods to determine a temperature of an electrode and two methods to adjust the temperature of the electrode are described. In an embodiment these four methods may be combined to obtain a desired accuracy as mentioned above. In such an embodiment, the cathode fall voltage is employed to determine a cold electrode and the voltage drop over the electrode (resistance of the electrode) is employed to determine a hot electrode. To heat the electrode, a heating current is supplied to the electrode and to cool the electrode a connection is made between the electrode shield and the current carrying lead wire. Of course, for performing such a combined method, both the lamp and the lamp driver circuit are designed accordingly:
the lamp is provided with means for determining the cathode fall voltage, e.g. a conducting band, a lamp cap or a terminal connected via a feed-through wire to the electrode shield; the lamp is provided with a connecting element for connecting the electrode shield and the current carrying lead wire;
the lamp driver circuit is configured to detect the temperature signals, i.e. the signal representing the provided cathode fall voltage and the signal representing the voltage drop over the electrode; and
the lamp driver circuit is configured to control the heating current and to control the connecting element provided in the lamp for making a connection between the electrode shield and the current carrying lead wire.

In an embodiment, the connecting element for connecting the electrode shield and the current carrying lead wire may be comprised in the lamp driver circuit. With an electrical connection between the electrode shield and the lamp driver circuit for determining a cathode fall voltage, it is possible to connect one of the contact terminals configured to receive a supply voltage or current to the electrode shield in the lamp driver circuit. Thus, in such an embodiment, the lamp is provided with a terminal connected to a feed through wire for enabling an electrical connection between the lamp driver circuit and the electrode shield; the lamp driver circuit or the control circuit thereof being provided with the connecting element for making a connection between the current carrying lead wire and the electrode shield.

The method may be performed by defining an upper limit and a lower limit for the temperature, and only adjusting the operating signals when the temperature does not lie within the range defined by said lower and upper limit. As well, the method may be performed by continuously controlling the operating signals in order to control the temperature of the electrode such that it is at or near a predefined optimum temperature at any time. A person skilled in the art will readily recognize these and other methods as suitable control methods for performing the method according to the present invention.

In the above description as well as in the appended claims, ‘comprising’ is to be understood as not excluding other elements or steps and ‘a’ or ‘an’ does not exclude a plurality. Further, any reference signs in the claims shall not be construed as limiting the scope of the invention.

1. Method for controlling a life time of a gas discharge lamp, the method comprising:
providing at least one temperature signal representing a temperature of an electrode of said lamp to a lamp driver circuit operating said lamp; and
controlling at least one operating signal supplied by said lamp driver circuit to said lamp in response to said temperature signal for controlling the electrode temperature to lie within a predetermined temperature range.

2. Method according to claim 1, wherein a temperature signal corresponds to a cathode fall voltage.

3. Method according to claim 2, wherein a conducting band is positioned around the lamp and said cathode fall voltage is determined by measuring a potential of said conducting band.

4. Method according to claim 2, wherein the lamp is provided with an electrode shield and said cathode fall voltage is determined by measuring a potential of the electrode shield.

5. Method according to claim 1, wherein a temperature signal corresponds to an electrode coil resistance.

6. Method according to claim 5, wherein the electrode coil resistance is determined by determining an electrode coil voltage.

7. Method according to claim 1, wherein the lamp driver circuit controls a heating current supplied to the lamp in response to the at least one temperature signal.

8. Method according to claim 1, wherein an electrical connection between an electrode shield and a current carrying lead wire is controlled by the lamp driver circuit in response to the at least one temperature signal.

9. Method according to claim 8, wherein impedance of a connection between the electrode shield and the current carrying lead wire is controlled in response to the temperature signal.

10. Assembly of a gas discharge lamp and a lamp driver circuit, wherein the lamp driver circuit and the lamp are operatively connected for supplying at least one operating signal from the lamp driver circuit to the lamp and for supplying at least one temperature signal representing an electrode temperature from the lamp to the lamp driver circuit, the lamp driver circuit comprising a control circuit for controlling at least one operating signal in response to said at least one temperature signal for controlling the electrode temperature to lie within a predetermined temperature range.

11. Gas discharge lamp for use in the assembly according to claim 10, wherein a conducting band is positioned around the lamp for determining a cathode fall voltage by measuring a potential of said conducting band.

12. Gas discharge lamp according to claim 11, wherein the conducting band is a lamp cap.

13. Gas discharge lamp for use in the assembly according to claim 10, wherein an electrode shield is provided around the electrode of the lamp and a feed through conductive wire provides an electrical connection between a terminal on the outside of the lamp and the electrode shield for electrically connecting the lamp driver circuit and the electrode shield.

14. Gas discharge lamp for use in the assembly according to claim 10, wherein a switching element is connected between an electrode shield and a lead wire and is electrically connectable to the lamp driver circuit for making an electrical connection between the electrode shield and the lead wire in response to an operating signal provided by the lamp driver circuit.

15. Gas discharge lamp for use in the assembly according to claim 10, wherein a controllable variable impedance element is connected between an electrode shield and a lead wire and is electrically connectable to the lamp driver circuit for making an electrical connection between the electrode shield and the lead wire, the impedance of the variable impedance element being controllable by the lamp driver circuit.

16. Lamp driver circuit for use in the assembly according to claim 10, wherein the lamp driver circuit comprises a control circuit configured to control at least one operating signal in response to at least one temperature signal.

17. Lamp driver circuit according to claim 16, wherein the operating signal is a heating current.

18. Lamp driver circuit according to claim 16, wherein the operating signal is a switch signal for controlling a switch of the lamp connected between an electrode shield and a lead wire.

19. Lamp driver circuit according to claim 16, wherein the operating signal is an impedance signal for controlling a variable impedance element of the lamp connected between an electrode shield and a lead wire.

20. Lamp driver circuit according to claim 16, wherein the at least one temperature signal comprises a cathode fall voltage signal.

21. Lamp driver circuit according to claim 16, wherein the at least one temperature signal comprises an electrode coil voltage signal.
